(19) United States
(12) Patent Application Publication
(10) Pub. No.: US 2006/0047492 A1
(43) Pub. Date: Mar. 2, 2006

(54) Circuit simulation methods and systems

(75) Inventors: Hsin-Lan Chang, Jhongli City (TW); Sheng-Yow Chen, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Airoha Technology Corp.

(21) Appl. No.: 11/215,289

(22) Filed: Aug. 30, 2005

(30) Foreign Application Priority Data
Aug. 31, 2004 (TW) 93126161

(51) Int. Cl. G06F 17/50

(52) U.S. Cl. 703/14

(57) ABSTRACT

A method for circuit simulation. Manufacturing parameters, geometry data and status case types are acquired, and provided to an extreme mismatch model. The extreme mismatch model comprises at least one simulation instruction simulating electrical features under the manufacturing parameters, geometry data and status case types. An extreme electrical feature is acquired by performing normal simulation employing the extreme mismatch model. The extreme electrical feature is outputted.

### BACKGROUND

The invention relates to circuit simulation, and more particularly, to methods and systems for extreme case simulation.

Design tools are typically employed by circuit designers to design integrated circuits (ICs). The most common design tools are simulated-program-with-integrated-circuit-emphasis (SPICE) and fast device level simulators (e.g., Star-Sim, ATS, MACH TA, and TIMEMILL). Typically, design tools, such as SPICE and fast device level simulators, describe an individual device and its connections in a line-by-line manner. Examples of individual devices are resistors, capacitors, inductors, bipolar junction transistors, and metal oxide semiconductor field effect transistors (MOSFETs). In a design tool, each line, which includes a description of a device, is sometimes referred to as a device specification instance.

A netlist developed by a design tool includes three sections, a circuit description section, a models section, and an analysis section. The circuit description section contains a description of the individual device and sub-circuit behavior. Typically, the models section comprises a library of model parameters, model parameter values, and model equations. Generally, the behavior of each type of device (e.g., a MOSFET) can be simulated by at least one model equation, which includes a combination of model parameters. The analysis section typically includes analysis instructions to simulate a device, sub-circuit, or circuit (e.g., output voltage over time) using information in the circuit description section and the model section.

Mismatch can be defined as the difference in device performance for similarly/identically designed devices operating under the same bias conditions. The effect of mismatch is not limited to only among devices; mismatch in device characteristics can lead designed circuits operating differently under the same bias conditions. Typically, whether among devices or circuits, the performance difference caused by mismatch is not a constant but has a statistical distribution. In particular, the effect of mismatch is dependent on device geometry, distances between devices, layout style, and temperature applied to a device.

Typically, the layout design phase is initiated after an IC is developed in the schematic design phase and may pass various simulations. The normal simulation is performed to determine whether a developed IC is regular under normal conditions. Monte Carlo simulation is subsequently performed to determine whether the developed IC is regular under mismatch phenomenon by utilizing a mismatch model.

The mismatch simulation using conventional Monte Carlo method requires numerous sampling procedures to produce all possible mismatch conditions, and is time-consuming, typically taking two hours to several days. Additionally, conventional mismatch simulation simulates all devices, lacking the capability to identify individual problems, such as a specific device or portion thereof.

### SUMMARY

Methods for circuit simulation are provided, an exemplary embodiment of which acquires manufacturing parameters, geometry data and status case types, and provides the acquired data in an extreme mismatch model. An extreme mismatch model comprises at least one simulation instruction for electrical features under manufacturing parameters, geometry data and status case types. A first extreme electrical feature is acquired by performing normal simulation employing the extreme mismatch model, and outputs the extreme electrical feature. A second extreme electrical feature may be further calculated with the acquired data using at least one extreme mismatch equation, with the second extreme electrical feature output.

A machine-readable storage medium storing a computer program which, when executed, performs the method of circuit simulation is also provided.

Systems for circuit simulation are further provided, an exemplary embodiment of which provides circuit design support. The system comprises a storage device, an output device, a data acquisition unit and a simulation unit. The storage device stores an extreme mismatch model, comprising at least one simulation instruction for electrical features under manufacturing parameters, geometry data and status case types. The data acquisition unit receives manufacturing parameters, geometry data and status case types. The simulation unit is coupled to the storage device, the output device and the data acquisition unit, and provides manufacturing parameters, geometry data and status case types in the extreme mismatch model, acquires a first extreme electrical feature by performing normal simulation employing the extreme mismatch model, and outputs the first extreme electrical feature via the output device. The system may further comprise a calculation unit coupled to the storage device, the output device and the data acquisition unit, calculating a second extreme electrical feature under manufacturing parameters, geometry data and status case types using at least one extreme mismatch equation, and outputting the second extreme electrical feature via the output device.

Preferably, simulation instruction simulates a first extreme electrical feature under manufacturing parameters with a mean value increasing/decreasing to a triple standard deviation, and the extreme mismatch equation calculates a second extreme electrical feature under manufacturing parameters with a mean value increasing/decreasing to a triple standard deviation.

### BRIEF DESCRIPTION OF THE DRAWINGS

Circuit simulation systems and methods will become apparent by referring to the following detailed description of embodiments with reference to the accompanying drawings, wherein:

FIG. 1 is a diagram of a hardware environment applicable to computers in an embodiment of a circuit simulation system;

FIG. 2 is a flowchart showing an embodiment of a method of circuit simulation method;

FIG. 3 is a system architecture diagram of an embodiment of a circuit simulation system;

FIG. 4 is a diagram of a storage medium storing a computer program providing an embodiment of a method of circuit simulation

### DETAILED DESCRIPTION

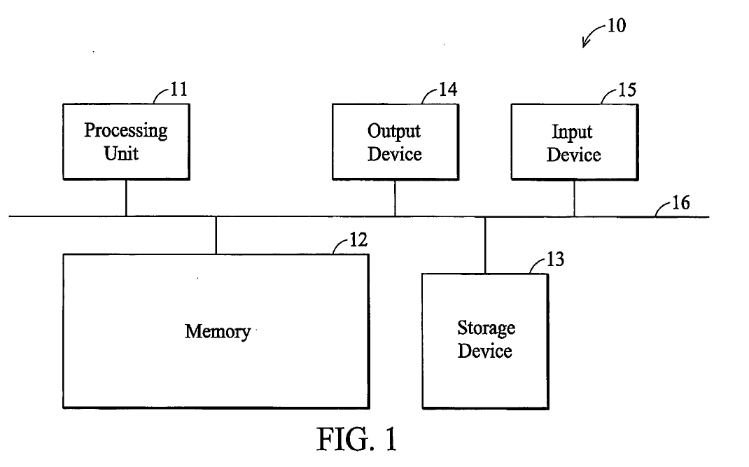

FIG. 1 is a diagram of a hardware environment applicable to computers in an embodiment of a circuit simulation system. The description of FIG. 1 is providing a brief, general description of suitable computer hardware and a suitable computing environment in conjunction with which at least some embodiments may be implemented. The hardware environment of FIG. 1 includes a processing unit 11, a memory 12, a storage device 13, an input device 15 and an output device 14. The processing unit 11 is connected by buses 16 to the memory 12, storage device 13, input device 15 and output device 14 based on Von Neumann architecture. Those skilled in the art will understand that at least some embodiments may be practiced with other computer system configurations, including hand-held devices, multiprocessor-based, microprocessor-based or programmable consumer electronics, network PCs, minicomputers, mainframe computers, and the like. There may be one or more processing unit 11, such that the processor of the computer comprises a single central processing unit (CPU), a micro processing unit (MPU) or multiple processing units, commonly referred to as a parallel processing environment. Memory 12 is preferably a random access memory (RAM), but may also include read-only memory (ROM) or flash ROM. The memory 12 preferably stores program modules executed by the processing unit 11 to perform circuit simulation functions. Generally, program modules include routines, programs, objects, components, or others, that perform particular tasks or implement particular abstract data types. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web object, Web Services or other similar architectures. The storage device 13 may be a hard drive, magnetic drive, optical drive, a portable drive, or nonvolatile memory drive. The drives and their associated computer-readable media (if required) provide nonvolatile storage of computer-readable instructions, data structures or program modules.

Storage device 13 stores program modules and extreme mismatch models. Each extreme mismatch model comprising at least one simulation instruction, receives one or more manufacturing parameters (e.g., line length, line width, thickness, materials and the like), geometry data (e.g., device length, device width and the like), and an extreme case type (e.g., a maximum case or a minimum case), simulates one or more electrical features (e.g., current, voltage, power level, resistance and the like). Alternatively, in some embodiments, manufacturing parameters may be directly assigned in extreme mismatch models. For example, a resistance may be infected by manufacturing parameters, such as line length, line width and sheet resistance for a particular material. Formula 1 shows calculation of an electrical resistance:
R=Rₛ*Lₗ/L_{w},
where Rₛ represents the sheet resistance, Lₗ represents the line length, and L_{w} represents the line width. Each sheet resistance for a particular material, line length and line width is calculated by a specific manufacturing parameter model. The manufacturing parameter model calculates the highest and lowest manufacturing parameters according to a parameter mean value and a parameter standard deviation. Preferably, the highest manufacturing parameters are calculated by adding a triple parameter standard deviation to a parameter mean value, and the lowest manufacturing parameters are calculated by subtracting a triple parameter standard deviation from a parameter mean value. Formula 2 shows calculation of highest and lowest sheet resistances:
Rₛ=μ_{Rs}+b*3σ_{Rs},
where P_{Rs} represents the mean value of sheet resistance, σ_{Rs} represents standard deviation of sheet resistance, and b is 1 or −1, whereby maximum sheet resistance is calculated with b=1 and minimum sheet resistance is calculated with b=−1. Formula 3 shows calculation of highest and lowest line length:
Lₗ=μ_{Ll}+b*3ν_{Ll},
where μ_{Ll}, represents mean value of line length, σ_{Ll} represents standard deviation of line length, and b is 1 or −1, whereby maximum line length is calculated with b=1, and minimum line length is calculated with b=−1. Formula 4 shows calculation of highest and lowest line width:
Rₛ=μ_{Lw}+b*3σ_{Lw},
where μ_{Lw} represents mean value of line width, σ_{Lw} represents standard deviation of line width, and b is 1 or −1, whereby maximum line width is calculated with b=1, and minimum line width is calculated with b=−1.

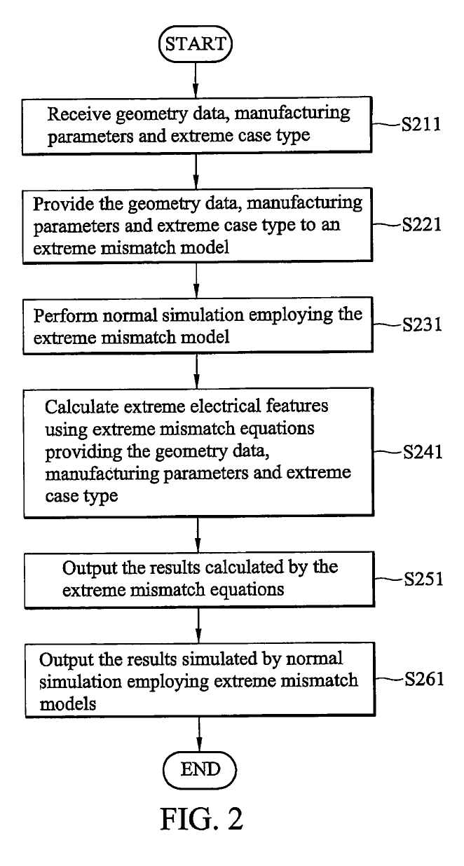

A method of circuit simulation is further provided, executed by the processing unit 11. FIG. 2 is a flowchart showing an embodiment of a method of circuit simulation. In step S211, geometry data (e.g., device length, device width and the like), manufacturing parameters (e.g., line length, line width, thickness, materials and the like), and the extreme case type (e.g., a maximum case or a minimum case) are received.

In step S221, the geometry data (e.g., device length, device width and the like), manufacturing parameters (e.g., line length, line width, thickness, materials and the like), and the extreme case type are provided to an extreme mismatch model. For example, the extreme simulation model comprising formula 1 to 4 are provided for acquisition of extreme cases of electrical features. Note that the extreme simulation model additionally comprises assignments for simulation conditions (e.g., operating temperature). In step S231, normal simulation employing the extreme mismatch model is performed.

To generate possible results as quickly as possible, steps S241 to S261 are performed. In step S241, extreme electrical features are calculated using extreme mismatch equations providing the geometry data, manufacturing parameters and extreme case types. Note that the extreme mismatch results calculated by extreme mismatch equations are less accurate than that those by normal simulations employing extreme mismatch models. For example, formula 1 to 4 can be employed as the simple equations. In step S251, the results calculated by the extreme mismatch equations are output via the output device 14. In step S261, the results simulated by normal simulation employing extreme mismatch models are output via the output device 14. Although the method has been described in an exemplary order, it is not limited thereto. Those skilled in the technology can perform variations without departing from the scope and spirit of this invention.

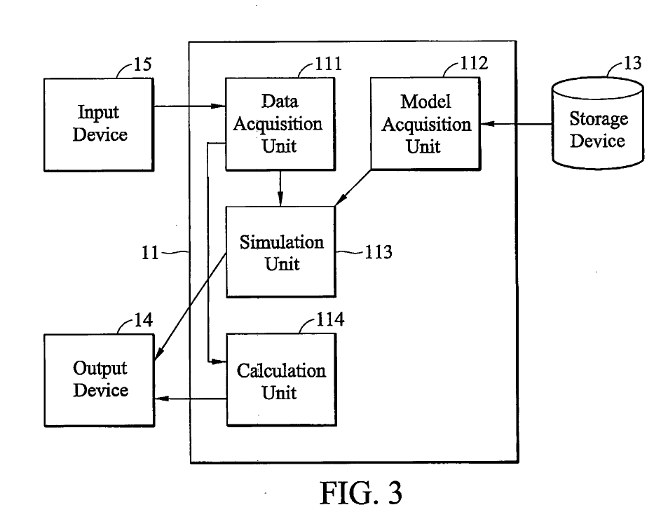

Circuit simulation system comprising program modules is provided. FIG. 3 is a system architecture diagram of an embodiment of a circuit simulation system, comprising a data acquisition unit 111, a model acquisition unit 112, a simulation unit 113 and a calculation unit 114.

The data acquisition unit 111 receives geometry data, manufacturing parameters and an extreme case type via the input device 15, preferably via a graphical user interface (GUI). The model acquisition unit acquires an extreme mismatch model from the storage device 13. The simulation unit 113 acquires the geometry data, manufacturing parameters and extreme case types from the data acquisition unit 111, and the extreme mismatch model from the model acquisition unit 112, performs normal simulation by providing the extreme mismatch model with the acquired data, and outputs the simulation result via the output device 14. The calculation unit 114 acquires the geometry data, manufacturing parameters and extreme case types from the data acquisition unit 111, acquires the extreme mismatch model from the model acquisition unit 112, calculates extreme electrical features using extreme mismatch equations with the acquired data, and outputs the calculation result via the output device 14.

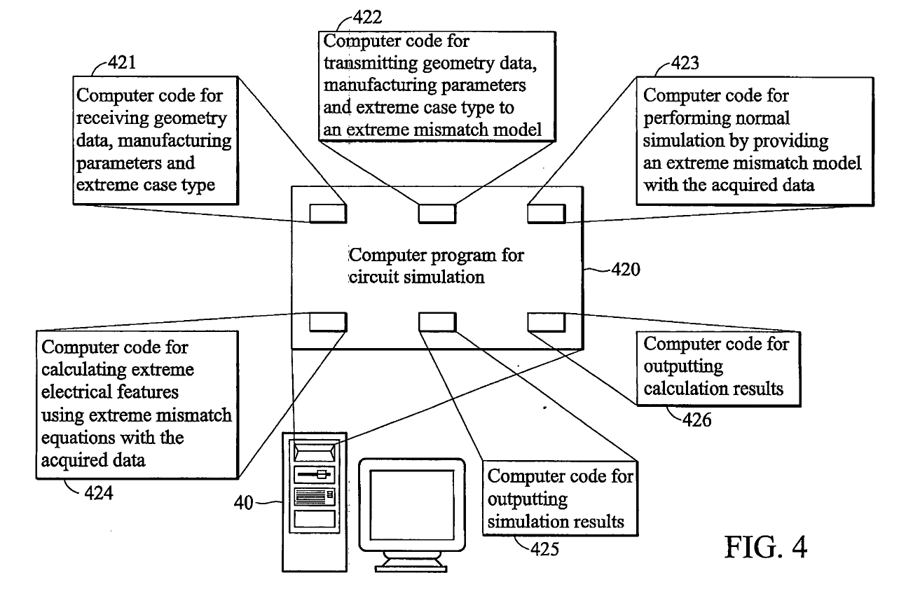

Further provided is a storage medium as shown in FIG. 4 storing a computer program 420 executing an embodiment of circuit simulation method, the storage medium 40 having computer readable program code embodied therein for use in a computer system, comprising at least computer readable program code 421 receiving geometry data, manufacturing parameters and extreme case types, computer readable program code 422 transmitting geometry data, manufacturing parameters and extreme case types to an extreme mismatch model, computer readable program code 423 performing normal simulation by providing an extreme mismatch model with the acquired data, computer readable program code 424 calculating extreme electrical features using extreme mismatch equations with the acquired data, computer readable program code 425 outputting simulation results and computer readable program code 426 outputting calculation results.

The methods and systems disclosed, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and systems of the invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention thereto. Those skilled in this technology can make various alterations and modifications without departing from the scope and spirit of the invention. Therefore, the scope of the invention shall be defined and protected by the following claims and their equivalents.

What is claimed is:

1. A method for circuit simulation, comprising:
acquiring manufacturing parameters, geometry data and status case types;
providing the manufacturing parameters, geometry data and status case types to an extreme mismatch model, the extreme mismatch model comprising at least one simulation instruction for simulating electrical features under the manufacturing parameters, geometry data and status case types;
acquiring a first extreme electrical feature by performing normal simulation employing the extreme mismatch model; and
outputting the first extreme electrical feature.

2. The method as claimed in claim 1 further comprising:
calculating a second extreme electrical feature under the manufacturing parameters, geometry data and status case types using at least one extreme mismatch equation; and
outputting the second extreme electrical feature.

3. The method as claimed in claim 2 wherein the extreme mismatch equation calculates the second extreme electrical feature under the manufacturing parameters with a mean value increasing/decreasing to a triple standard deviation.

4. The method as claimed in claim 1 wherein the extreme case type is the highest case or the lowest case.

5. The method as claimed in claim 1 wherein the simulation instruction simulates the first extreme electrical feature under the manufacturing parameter with a mean value increasing/decreasing to a triple standard deviation.

6. A machine-readable storage medium storing a computer program which, when executed, performs a method for circuit simulation, the method comprising:
acquiring manufacturing parameters, geometry data and status case types;
providing the manufacturing parameters, geometry data and status case types to an extreme mismatch model, the extreme mismatch model comprising at least one simulation instruction for simulating electrical features under the manufacturing parameters, geometry data and status case types;
acquiring a first extreme electrical feature by performing normal simulation employing the extreme mismatch model; and
outputting the first extreme electrical feature.

7. The machine-readable storage medium as claimed in claim 6 wherein the method further comprises the steps of:
calculating a second extreme electrical feature under the manufacturing parameters, geometry data and status case types using at least one extreme mismatch equation; and
outputting the second extreme electrical feature.

8. The machine-readable storage medium as claimed in claim 7 wherein the extreme mismatch equation calculates the second extreme electrical feature under the manufacturing parameters with a mean value increasing/decreasing to a triple standard deviation.

9. The machine-readable storage medium as claimed in claim 6 wherein the extreme case type is the highest case or the lowest case.

10. The machine-readable storage medium as claimed in claim 6 wherein the simulation instruction is provided for simulating the first extreme electrical feature under the manufacturing parameter with a mean value increasing/decreasing to a triple standard deviation.

11. A system for circuit simulation, comprising:
a storage device storing an extreme mismatch model, the extreme mismatch model comprising at least one simulation instruction simulating electrical features under manufacturing parameters, geometry data and status case types;
an output device;
a data acquisition unit receiving the manufacturing parameters, geometry data and status case types; and
a simulation unit coupled to the storage device, the output device and the data acquisition unit, providing the manufacturing parameters, geometry data and status case type to the extreme mismatch model, acquiring a first extreme electrical feature by performing normal simulation employing the extreme mismatch model, and outputting the first extreme electrical feature via the output device.

12. The system as claimed in claim 11 further comprising a calculation unit coupled to the storage device, the output device and the data acquisition unit, calculating a second extreme electrical feature under the manufacturing parameters, geometry data and status case types using at least one extreme mismatch equation, and outputting the second extreme electrical feature via the output device.

13. The system as claimed in claim 12 wherein the extreme mismatch equation calculates the second extreme electrical feature under the manufacturing parameters with a mean value increasing/decreasing to a triple standard deviation.

14. The system as claimed in claim 11 wherein the extreme case type is the highest case or the lowest case.

15. The system as claimed in claim 11 wherein the simulation instruction simulates the first extreme electrical feature under the manufacturing parameters with a mean value increasing/decreasing to a triple standard deviation.
